(19) United States
(12) Patent Application Publication
(10) Pub. No.: US 2005/0195183 A1
(43) Pub. Date: Sep. 8, 2005

(54) Clock control for a graphics processor

(76) Inventor: Michael Hugh Anderson, Leucadia, CA (US)

Correspondence Address: Qualcomm Incorporated;Patents Department, 5775 Morehouse Drive, San Diego, CA, 92121-1714, US

(21) Appl. No.: 10/928,526

(22) Filed: Aug. 26, 2004

Related U.S. Application Data
(60) Provisional application No. 60/550,028, filed on Mar. 3, 2004.

(51) Int. Cl. G06T 15/40; G06T 1/00

(52) U.S. Cl. 345/418

(57) ABSTRACT

A graphics processor and method is disclosed wherein a surface processing engine is configured to receive vertex information and assemble a plurality of surfaces based on the vertex information, the surfaces representing a graphic image. A pixel processing engine may be configured to render the assembled surfaces into pixel information. A clock control module may be configured to provide a surface clock to the surface processing engine, and a pixel clock to the pixel processing engine, each of the clocks having a rate that is adjustable independent of the other clock.

The present application claims the benefit of U.S. Provisional Application Patent No. 60/550,028 filed Mar. 3, 2004.

### BACKGROUND

1. Field

The present disclosure relates generally to graphic imaging, and more specifically, to systems and techniques for dynamically adjusting clocks for individual modules of a graphics processor.

2. Background

The integration of electronic games and multi-media presentations into personal computers, laptops, mobile phones, personal digital assistants (PDA) and other devices has become mainstream in today's consumer electronic marketplace. These electronic games and multi-media presentations are supported through technology known as three-dimensional (3D) graphics. 3D graphics is used to create graphic images, and project those images onto a two-dimensional (2D) display. This may be achieved by converting the graphic image into a 3D wireframe structure consisting of smaller components, such as triangles, squares, rectangles, parallelograms, or other suitable surfaces. The 3D wireframe structure may then be transformed into 2D display space with each surface of the wireframe being defined by the coordinates of its vertices. Attributes such as color, texture, transparency and depth may be tagged onto the vertices for each surface. The process of rendering a surface into pixel information involves interpolating the attributes of the vertices across the surface.

The amount of time it takes to render a surface into pixel information depends on the area of the surface. Large surfaces with lots of pixels take a relatively long time to render in comparison to smaller surfaces with fewer pixels. Thus, a pixel processing engine that continuously renders small surfaces into pixel information may be starved for a constant flow of new surfaces. Conversely, the pixel processing engine may not be able to render surfaces quickly enough when the surfaces are large, requiring some type of buffering scheme. Either way, increased power consumption may result from an idle pixel processing engine in the case of small surfaces, or buffering in the case of large surfaces. Accordingly, what is needed is a 3D graphics system in which a new surface can be provided to the pixel processing engine as soon as it completes the processing of the current surface.

### SUMMARY

In one aspect of the present invention, a graphics processor includes a surface processing engine configured to receive vertex information and assemble a plurality of surfaces based on the vertex information, the surfaces representing a graphic image, a pixel processing engine configured to render the assembled surfaces into pixel information, and a clock control module configured to provide a surface clock to the surface processing engine, and a pixel clock to the pixel processing engine, each of the clocks having a rate that is adjustable independent of the other clock.

In another aspect of the present invention, a method of graphic imaging includes using a surface clock to assemble a plurality of surfaces based on the vertex information, the surfaces representing a graphic image. The method also includes using a pixel clock to render the assembled surfaces into pixel information, and adjusting the rate of each of the clocks independently of the other clock.

In a further aspect of the present invention, a graphics processor includes means for assembling a plurality of surfaces based on vertex information, the surfaces representing a graphic image. The graphics processor also includes means for rendering the assembled surfaces into pixel information, and means for generating a surface clock to support the assembly of the surfaces, and generating a pixel clock to support the rendering of the assembled surfaces into the pixel information, each of the clocks having a rate that is adjustable independent of the other clock.

It is understood that other embodiments of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

Aspects of the present invention are illustrated by way of example, and not by way of limitation, in the accompanying drawings, wherein:

FIG. 1 is a conceptual block diagram of a 3D graphics system illustrating the operation of an application processor;

FIG. 2 is a conceptual block diagram of a 3D graphics system illustrating the operation of a graphics processor;

FIG. 3 is a conceptual block diagram of a clock control module in a graphics processor;

FIG. 4 is an alternative embodiment of a clock control module in a graphics processor; and

FIG. 5 is yet another embodiment of a clock control module in a graphics processor.

### DETAILED DESCRIPTION

The detailed description set forth below in connection with the appended drawings is intended as a description of various embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention.

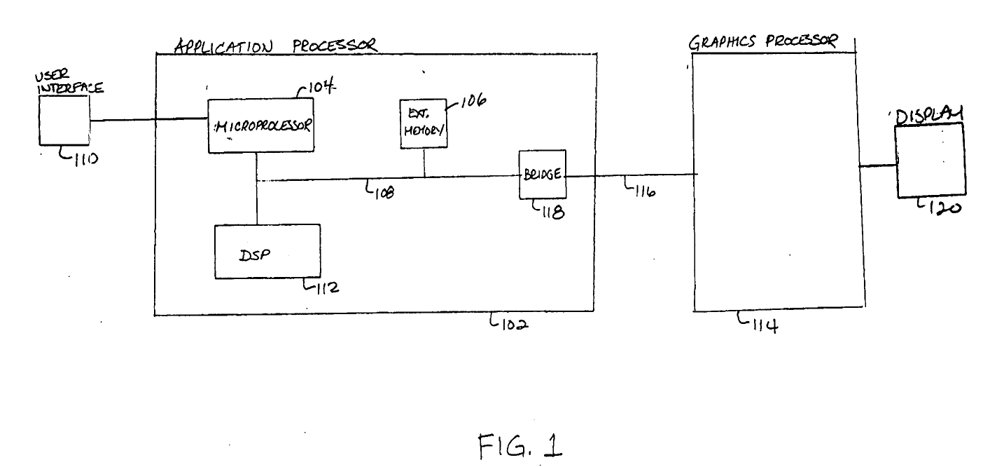

FIG. 1 is a conceptual block diagram illustrating a 3D graphics system integrated into a personal computer, laptop, mobile phone, PDA, or other suitable device. The 3D graphics system may include an application processor 102. The purpose of the application processor 102 is to generate 3D graphic images and convert those images into wireframe structures.

The application processor 102 may be any software or hardware implemented entity. In the embodiment of the 3D graphics system shown in FIG. 1, the application processor 102 includes a microprocessor 104 with external memory 106. A system bus 108 may be used to support communications between the two. The microprocessor 104 may be used to provide a platform to run various software programs, such as 3D graphics software for electronic games. The software may be programmed into external memory 106 at the factory, or alternatively, downloaded during operation from a remote server through a wireless link, a telephone line connection, a cable modem connection, a digital subscriber line (DSL), a fiber optic link, a satellite link, or any other suitable communications link.

In electronic game applications, the software may be used to create a virtual 3D world to represent the physical environment in which the game will be played. A user may be able to explore this virtual 3D world by manipulating a user interface 110. The user interface 110 may be a keypad, a joystick, a trackball, a mouse, or any other suitable device that allows the user to maneuver through the virtual 3D world—move forward or backward, up or down, left or right. The software may be used to produce a series of 3D graphic images that represent what the user might see as he or she maneuvers through this virtual 3D world.

The application processor 102 may also include a DSP 112 connected to the system bus 108. The DSP 112 may be implemented with an embedded graphics software layer which runs application specific algorithms to reduce the processing demands on the microprocessor 104. The DSP 112 may be used to break up each of the 3D graphic images into surfaces to create a wireframe structure. In at least one embodiment of the application processor 102, the surfaces are triangles. Alternatively, the surfaces may be squares, rectangles, parallelograms, or any other suitable surfaces. The wireframe structure may then be given an exterior surface that includes color, specular color, transparency, and texture. The DSP 112 may also apply various lighting models to the exterior surface elements.

The DSP 112 may also perform other processing functions such as back face culling and clipping. Back face culling may be used to remove the portions of the 3D graphic image, and particularly the back side of the image, that would not be seen by a user. The 3D graphic image may also be clipped to remove those portions of the image outside the display.

The wireframe structures, with their exterior surface elements, may then be transformed by the DSP 112 from 3D mathematical space to 2D display space. In 2D display space, each surface may be defined by its area and the display coordinates of its vertices. The surface attributes may include depth (Z), color (R,G,B), specular color (R_{S}, G_{S}, B_{S}), texture (U, V), and blending information (A). Blending information relates to transparency and specifies how the pixel's colors should be merged with another pixel when the two are overlaid, one on top of the other. The display coordinates and surface attributes for each surface will be referred to herein as “vertex information.” The vertex information generated by the DSP 112 may be stored in the external memory 106, or alternatively, in the DSP's internal memory.

A graphics processor 114 may be used to render each surface into pixel information by interpolating the attributes of its vertices across the entire surface. The graphics processor 114 may be integrated into the application processor 102 and implemented with the microprocessor 104, the DSP 112, or any other component in the application processor 102. Alternatively, the functionality of the graphics processor 114 may be distributed among the microprocessor 104, the DSP 112, and/or any other components in the application processor 102.

In at least one embodiment of the 3D graphics system, the graphics processor 114 is a stand-alone processor that communicates with the application processor 102 over an external bus 116, or by other means. A bridge 118 may be used to transfer data between the external bus 116 and the system bus 108. The purpose of a stand-alone graphics processor 114 is to reduce the load on the application processor 102 by removing the surface rendering function to specialized hardware components. The use of specialized hardware components may allow the graphics processor 114 to perform its processing functions very quickly. However, as those skilled in the art will appreciate, the graphics processor 114 is not limited to a hardware configuration. The graphics processor 114 may be implemented in any manner depending on the particular graphics application and the overall design constraints of the system.

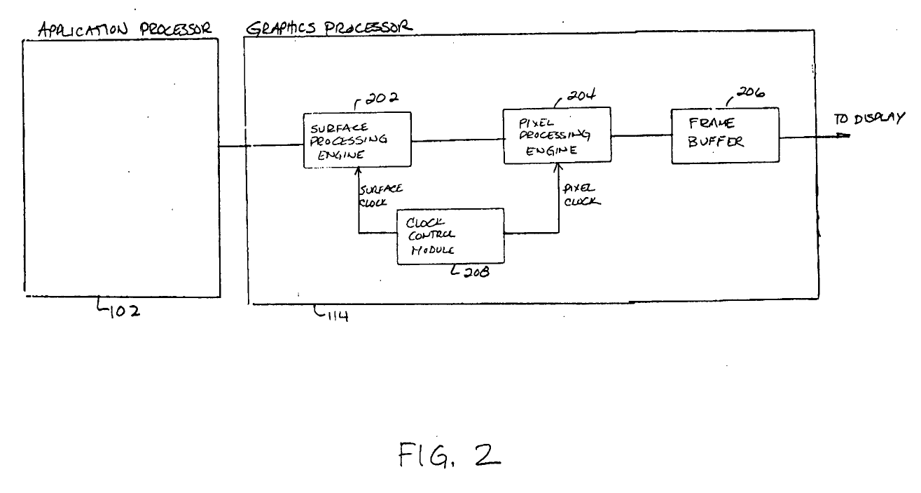

FIG. 2 is a conceptual block diagram of a graphics processor. The graphics processor 114 may be used to render each surface generated by the application processor 102 into pixel information using an interpolation process to fill the interior of the surface based on the location of the pixels within the surface and the attributes defined at the vertices.

To illustrate an example of this concept, a brief discussion will follow for triangular surfaces with the understanding that these principles can readily be extended to other surfaces by those skilled in the art. Every attribute of a vertex may be represented by a linear equation as a function of the display coordinates (x,y) as follows:
K(x,y)=Aₖx+Bₖy+Cₖ (1)
where k=Z, A, R, G, B, R_{S}, G_{S}, B_{S}, U, V.

The interior of the triangle may be defined by edge equations. A triangle's three edges may be represented by linear equations as a function of the display coordinates (x,y) as follows:
E₀(x,y)=A₀x+B₀y+C₀ (2)
E₁(x,y)=A₁x+B₁y+C₁ (3)
E₂(x,y)=A₂x+B₂y+C₂ (4)

The graphics processor 114 may include a surface processing engine 202 and a pixel processing engine 204. The surface processing engine 202 may be used to retrieve the vertex information from the application processor 102 and assemble triangles from the retrieved vertex information. The process of assembling a triangle involves extracting from the vertex information the triangle's area, the display coordinates for the triangle's three vertices, and the vertex attributes for the triangle. This information may be used to compute the attribute coefficients (Aₖ, Bₖ, Cₖ) and the edge coefficients (A₀₋₂, B₀₋₂, C₀₋₂) of the triangle. An assembled triangle includes the extracted vertex information for that triangle plus the triangle's attribute and edge coefficients. In at least one embodiment of the graphics processor 114, the surface processing engine 202 provides one assembled triangle at a time to the pixel processing engine 204.

The pixel processing engine 204 may be used to perform linear interpolation for each pixel's attributes within the assembled triangle. This may be done in a variety of fashions. By way of example, the pixel processing engine 204 may create a bounding box around the triangle, and then step through the bounding box pixel-by-pixel in a raster scan fashion. For each pixel, the pixel processing engine 204 determines whether the pixel is in the triangle using the edge equations set forth in equations (2)-(4) above. If the pixel processing engine 204 determines that the pixel is not in the triangle, then the pixel processing engine 204 goes to the next pixel. If, however, the pixel processing engine 204 determines that the pixel is in the triangle, then the pixel processing engine 204 may compute the pixel's attributes from equation (1). This process is well known in the art.

Once the triangles are rendered into pixel information, the pixel processing engine 204 may be used to remove hidden pixels when one object is in front of another object. This may be achieved by comparing the depth attribute of new pixel against the depth attribute of a previously rendered pixel having the same display coordinates and drop pixels that are not visible.

The pixel processing engine 204 may use the interpolated texture attributes to retrieve texture data from memory (not shown). The attributes for each pixel may then be blended with the texture data. The attributes for each pixel may be further blended with any-previously rendered pixel having the same display coordinates to create a transparency effect. The results may be stored in a frame buffer 206 before being presented to a display 120 (see FIG. 1).

A clock control module 208 may be used to provide clocks to the surface processing engine 202 and the pixel processing engine 204. As discussed earlier, the surface processing engine 202 may be configured to provide one assembled surface at a time to the pixel processing engine 204. To avoid unnecessary processing delays, the surface processing engine 202 should provide new surfaces to the pixel processing engine 204 as quickly as the pixel processing engine 204 can handle them. However, the surfaces assembled by the surface processing engine 202 should not be provided to the pixel processing engine 204 too quickly. The pixel processing engine 204 requires a finite amount of time to render each surface, and if the surfaces are provided to the pixel processing engine 204 before the pixel processing engine 204 is ready for them, buffering may be required. In addition, increased power consumption may result because the surface processing engine 202 is operating faster than it needs to. To further complicate the matter; the amount of time it takes for the pixel processing engine 204 to render a surface into pixel information varies. Large surfaces with lots of pixels take a relatively long time to render in comparison to smaller surfaces.

To optimize performance, the clock control module 208 may provide separate clocks to the surface processing engine 202 and the pixel processing engine 204. A surface clock may be used to control the rate of the surface processing engine 202, and a pixel clock may be used to control the rate of the pixel processing engine 204. In one embodiment of the graphics processor 114, the clock rates may be adjusted dynamically to maintain optimal performance under changing 3D graphic conditions. By way of example, the rate of the surface clock may be adjusted so that it varies in inverse proportion to the area of the surface, and/or the rate of the pixel clock may be adjusted so that it varies in direct proportion to the area of the surface. The term “direct proportion” means that the clock rate and area increase or decrease together, and the term “inverse proportion” means that the clock rate increases with a decrease in area, or the clock rate decreases with an increase in area.

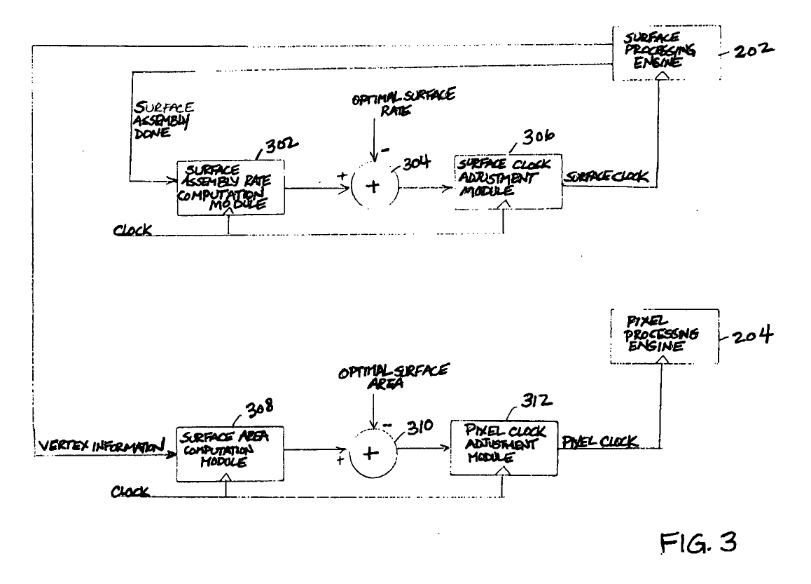

FIG. 3 is a function block diagram illustrating one embodiment of a clock control module operating in a graphics processor. Two independent feedback loops may be used to control the rates of the clocks. The surface clock uses feedback from the surface processing engine 202 that indicates when the assembly for each surface is complete. A surface assembly rate computation module 302 may be used to compute the actual rate at which the surfaces are assembled based on the feedback it receives from the surface processing engine 202. A comparator, such as an adder 304, may be used to compare the actual rate computed by the surface rate computation module 302 with an optimal surface assembly rate. A throttle signal representing the difference between the actual rate at which the surfaces are assembled and the optimal rate may be provided to a clock adjustment module 306 to adjust the rate of the surface clock. More specifically, the throttle signal may be used to increase the rate of the surface clock if the surfaces are being assembled by the surface processing engine 202 at a rate below the optimal surface assembly rate, and decrease the rate of the surface clock if the surfaces are being assembled by the surface processing engine 202 at a rate above the optimal surface assembly rate. In the steady state condition, the surface clock rate should stabilize so that the surface processing engine 202 assembles surfaces at the optimal rate.

The optimal surface assembly rate may be computed by the application processor 102 based on the system performance requirements. By way of example, the optimal surface assembly rate may be set relatively high for a high resolution system because of the exorbitant number of surfaces required to build the wireframe structure. If the resolution requirements are relaxed, the optimal surface assembly rate may also be reduced accordingly.

The pixel clock also uses feedback from the surface processing engine 202 relating to the area of each assembled surface. A surface area computation module 308 may be used to compute the area of the surface from the surface vertices assembled by the surface processing engine 202. Alternatively, the area of the surface may be provided directly from the application processor 102. Either way, a comparator, such as an adder 310, may be used to compare the area of the surface with an optimal surface area. The optimal surface area will again depend on the 3D graphic resolution requirements with smaller areas for high resolution presentations. A throttle signal representing the difference between the actual surface area and the optimal surface area may be provided to a clock adjustment module 312 to adjust the rate of the pixel clock. More specifically, the throttle signal may be used to increase the rate of the pixel clock if the actual surface is larger than the optimal surface, and decrease the rate of the pixel clock if the actual surface is smaller than the optimal surface.

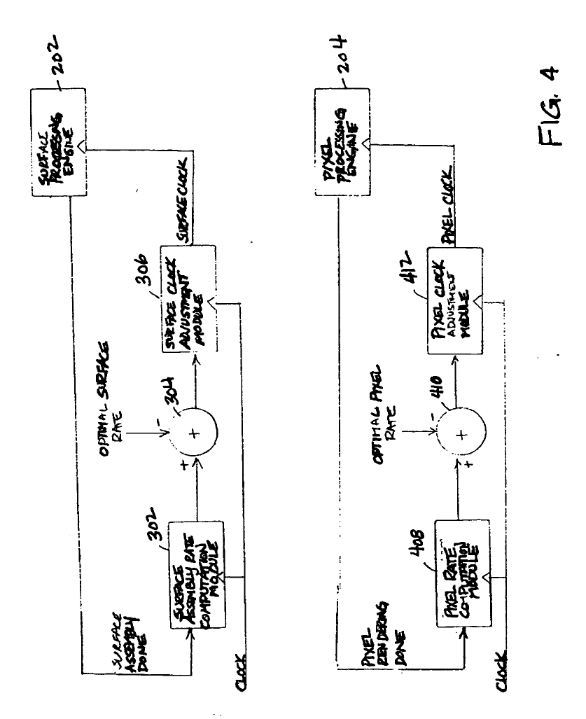

FIG. 4 is a function block diagram illustrating another embodiment of a clock control module operating in a graphics processor. Two independent feedback loops may be used to control the rates of the clocks. The feedback loop controlling the rate of the surface clock is identical to that of FIG. 3, and therefore, will not be discussed further. The feedback loop controlling the rate of the pixel clock, on the other hand, uses a slightly different approach. Instead of using the area of the surfaces being assembled by the surface processing engine 202 to set the pixel clock rate, the feedback loop is used to drive the pixel clock rate to an optimal setting. More specifically, an optimal pixel processing rate is computed by the application processor based on the system performance requirements. By way of example, the optimal pixel processing rate may be set relatively high for high resolution displays. The optimal pixel processing rate may be reduced without compromising performance in lower resolution applications.

In the embodiment shown in FIG. 4, the pixel clock uses feedback from the pixel processing engine 204 that indicates When the processing for each pixel is complete. A pixel rate computation module 408 may be used to compute the actual rate at which the pixels are processed based on the feedback it receives from the pixel processing engine 204. A comparator, such as an adder 410, may be used to compare the actual rate computed by the pixel rate computation module 408 with the optimal pixel processing rate. A throttle signal representing the difference between the actual rate in which the pixels are processed and the optimal rate may be provided to a clock adjustment module 412 to adjust the rate of the pixel clock. More specifically, the throttle signal may be used to increase the rate of the pixel clock if the pixels are being processed by the pixel processing engine 204 at a rate below the optimal pixel processing rate, and decrease the rate of the pixel clock if the pixels are being processed by the pixel processing engine 204 at a rate above the optimal pixel processing rate. In the steady state condition, the pixel clock rate should stabilize so that the pixel processing engine 204 processes pixels at the optimal rate.

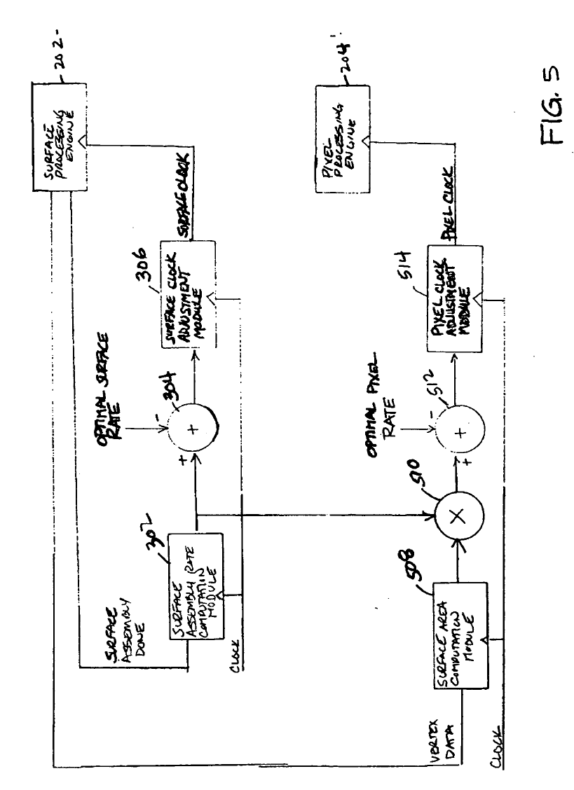

FIG. 5 is a function block diagram illustrating yet another embodiment of a clock control module operating in a graphics processor. This clock control module is a slight variation to that discussed in connection with FIG. 4. In both cases, one feedback loop is used to drive the surface clock to produce an optimal surface assembly rate, and another feedback loop is used to set the rate of the pixel clock to produce an optimal pixel processing rate. However, unlike the clock control module of FIG. 4, feedback from the pixel processing engine 204 is either not used or unavailable. Instead, feedback from the surface processing engine 202 is used. More specifically, feedback from the surface processing engine 202 identifying the vertices of each assembled surface are provided to a surface area computation module 508, and the area of the surface is computed. Alternatively, the area of the surface may be provided directly from the application processor 102. Either way, a multiplier 510 may be used to multiply the area of the surface with the actual surface assembly rate by the surface processing engine 202. The actual surface assembly rate may be pulled off from the feedback loop used to generate the surface clock. The product of the surface area and the actual surface assembly rate may be compared to the optimal pixel processing rate using a comparator such as an adder 512. A throttle signal representing the difference between the two may be provided to a clock adjustment module 514 to adjust the clock rate of the pixel clock. Thus, in this embodiment, the throttle signal will be driven harder when either the surface area or the surface assembly rate increases, resulting in a similar increase in the pixel clock rate.

The various illustrative logical blocks, engines, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing components, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A graphics processor, comprising;
a surface processing engine configured to receive vertex information and assemble a plurality of surfaces based on the vertex information, the surfaces representing a graphic image;
a pixel processing engine configured to render the assembled surfaces into pixel information; and
a clock control module configured to provide a surface clock to the surface processing engine, and a pixel clock to the pixel processing engine, each of the clocks having a rate that is adjustable independent of the other clock.

2. The graphics processor of claim 1 wherein each of the surfaces comprises a triangle.

3. The graphics processor of claim 1 wherein the clock control module is further configured to adjust the rate of at least one of the clocks so that it varies with the area of the surfaces.

4. The graphics processor of claim 1 wherein the clock control module is further configured to adjust the rate of the pixel clock so that it varies in direct proportion to the area of the surfaces.

5. The graphics processor of claim 1 wherein the clock control module is further configured to adjust the rate of the surface clock so that it varies in inverse proportion to the area of the surfaces.

6. The graphics processor of claim 1 wherein the clock control module is further configured to adjust the rate of the pixel clock based on a comparison between the area of the surfaces and a predetermined surface area.

7. The graphics processor of claim 6 wherein the clock control module further comprises generate a pixel clock throttle signal by comparing the computed area of the surfaces with the predetermined triangle area, and a pixel clock adjustment module configured to adjust the rate of the pixel clock as a function of the pixel clock throttle signal.

8. The graphics processor of claim 1 wherein the clock control module is further configured to adjust the rate of the pixel clock based on a comparison between the rate at which the pixel processing engine renders pixels and a predetermined pixel rendering rate.

9. The graphics processor of claim 8 wherein the clock control module further comprises a computation module configured to compute the rate at which the pixel processing engine processes pixels, a comparator configured to generate a pixel clock throttle signal by comparing the computed rate at which the pixel processing engine processes pixels with the predetermined pixel rendering rate, and a pixel clock adjustment module configured to adjust the rate of the pixel clock as a function of the pixel clock throttle signal.

10. The graphics processor of claim 1 wherein the clock control module is further configured to adjust the rate of the surface clock based on a comparison between the rate at which the surface processing engine assembles the surfaces and a predetermined surface assembly rate.

11. The graphics processor of claim 10 wherein the clock control module further comprises module configured to compute the rate at which the surface processing engine assembles the triangles, a comparator configured to generate a surface clock throttle signal by comparing the computed rate at which the surface processing engine assembles surfaces with the predetermined triangle assembly rate, and a surface clock adjustment module configured to adjust the rate of the surface clock as a function of the surface clock throttle.

12. The graphics processor of claim 10 wherein the clock control module is further configured to adjust the rate of the pixel clock as a function of the area of the triangles, the rate at which the surface processing engine assembles triangles, and a predetermined pixel processing rate.

13. The graphics processor of claim 12 wherein the clock control module further comprises a computation module configured to compute the area of the surfaces, a multiplier configured to multiply the computed area with the rate at which the surface processing engine assembles surfaces to produce a product, a comparator configured to generate a pixel clock throttle signal by comparing the product with the predetermined pixel processing rate, and a pixel clock adjustment module configured to adjust the rate of the pixel clock as a function of the pixel clock throttle signal.

14. A method of graphic imaging, comprising;
using a surface clock to assemble a plurality of surfaces based on vertex information, the surfaces representing a graphic image;
using a pixel clock to render the assembled surfaces into pixel information; and
adjusting the rate of each of the clocks independently of the other clock.

15. The method of claim 14 wherein each of the surfaces comprises a triangle.

16. The method of claim 14 wherein the rate of at least one of the clocks is adjusted so that it varies with the area of the surfaces.

17. The method of claim 14 wherein the rate of the pixel clock is adjusted so that it varies in direct proportion to the area of the surfaces.

18. The method of claim 14 wherein the rate of the surface clock is adjusted so that it varies in inverse proportion to the area of the surfaces.

19. The method of claim 14 wherein the rate of the pixel clock is adjusted based on a comparison between the area of the surfaces and a predetermined surface area.

20. The method of claim 14 wherein the rate of the pixel clock is adjusted based on a comparison between the rate at which the pixels are processed and a predetermined pixel processing rate.

21. The method of claim 14 wherein the rate of the surface clock is adjusted based on a comparison between the rate at which the surfaces are assembled and a predetermined surface assembly rate.

22. The method of claim 14 wherein the rate of the pixel clock is adjusted by multiplying the area of the triangles with the rate at which the triangles are assembled to produce a product, and comparing the product with a predetermined pixel processing rate.

23. A graphics processor, comprising;
means for assembling a plurality of surfaces based on vertex information, the surfaces representing a graphic image;
means for rendering the assembled surfaces into pixel information; and
means for generating a surface clock to support the assembly of the surfaces, and generating a pixel clock to support the rendering of the assembled surfaces into the pixel information, each of the clocks having a rate that is adjustable independent of the other clock.
